(19) United States
(12) Patent Application Publication
(10) Pub. No.: US 2011/0134207 A1
(43) Pub. Date: Jun. 9, 2011

(54) Audio/video System

(76) Inventors: Timothy J Corbett, Corvallis, OR (US); David R. Ingalls, Corvallis, OR (US); Scott Grasley, Lebanon, OR (US)

(21) Appl. No.: 13/058,446

(22) PCT Filed: Aug. 13, 2008
(86) PCT No.: PCT/US08/72982

§ 371 Date: Feb. 10, 2011

(51) Int. Cl. H04N 5/60; H04N 7/15

(52) U.S. Cl. 348/14.08; 348/738; 348/E07.083; 348/E05.123

(57) ABSTRACT

In an embodiment of an audio/video system, an audio signal is sent to a plurality of speakers of the audio/video system, and a delay and/or a gain applied to the audio signal sent to each speaker is adjusted according to a distance from that speaker to an apparent sound origin on a video display of the audio/video system.

### BACKGROUND

Video conferencing is an established method of simulated face-to-face collaboration between participants located at one or more remote environments and participants located at a local environment. Typically, one or more cameras, one or more microphones, one or more video displays, and one or more speakers are located at the remote environments and the local environment. This allows participants at the local environment to see, hear, and talk to the participants at the remote environments. For example, video images at the remote environments are broadcast onto the one or more video displays at the local environment and accompanying audio signals (e.g., sometimes referred to as an audio images) are broadcast to the one or more speakers (e.g., sometimes referred to as an audio display) at the local environment.

One of the objectives of videoconferencing is to create a quality telepresence experience, where the participants at the local environment feel is though they are actually present at a remote environment and are interacting with participants at the remote environments. However, one of the problems in creating a quality telepresence experience is a directionality mismatch between the audio and video images. That is, the sound of a participant's voice may appear to be coming from a location that is different from where that participant's image is located on the video display. For example, the participant who is speaking may appear at the left of the video display, but the sound may appear to be coming from the right of the video display.

### DESCRIPTION OF THE DRAWINGS

FIG. 1 is a block diagram illustrating an embodiment of audio/video system, according to an embodiment of the disclosure.

FIG. 2 illustrates an embodiment of a speaker and video display setup of an embodiment of an audio/video system in a room, according to another embodiment of the disclosure.

FIG. 3 is a block diagram illustrating an embodiment of the audio components of an embodiment of an audio/video system, according to another embodiment of the disclosure.

### DETAILED DESCRIPTION

In the following detailed description of the present embodiments, reference is made to the accompanying drawings that form a part hereof, and in which are shown by way of illustration specific embodiments that may be practiced. These embodiments are described in sufficient detail to enable those skilled in the art to practice disclosed subject matter, and it is to be understood that other embodiments may be utilized and that process, electrical or mechanical changes may be made without departing from the scope of the claimed subject matter. The following detailed description is, therefore, not to be taken in a limiting sense, and the scope of the claimed subject matter is defined only by the appended claims and equivalents thereof.

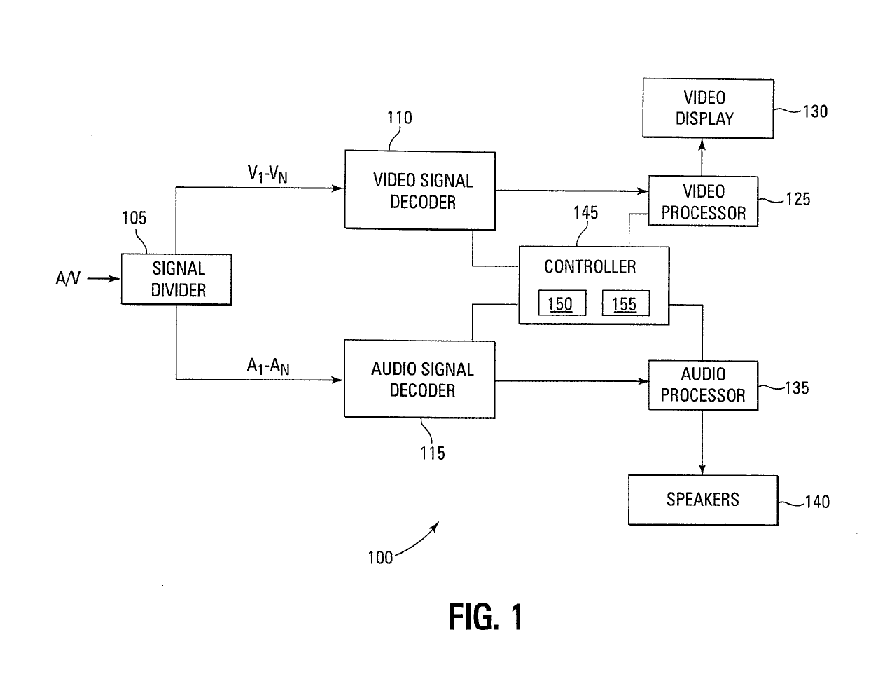

FIG. 1 is a block diagram illustrating an audio/video system 100, e.g., that may be used in a room, such as a video conference room, according to an embodiment.

Audio/video system 100 receives an encoded combined audio/video signal A/V from an audio/video source, such as an audio/video system of one or more remote video conference rooms, over a network, for example. For example, encoded combined audio/video signal A/V may be received at a signal divider 105, such as a transport processor, that extracts an encoded audio signal A and an encoded video signal V from audio/video signal A/V.

Encoded video signal V and encoded audio signal A are respectively decoded at a video signal decoder 110 and an audio signal decoder 115. The decoded video signal is sent to a video processor 125 that in turn sends a processed video signal, for one embodiment, to a projector, e.g., as part of a front or rear projection system, that projects images contained in the video signal onto a video display 130, such as a passive display or an active display with electronics, either from the front or the rear. For another embodiment, video display 130 may be a projectionless display, such as a liquid crystal display or a plasma display, in which case the video signals are sent directly from video processor 125 to video display 130.

The decoded audio signal is sent to an audio processor 135 that in turn sends a processed audio signal to one or more speakers 140. A controller 145 sends signals (e.g., referred to as commands or instructions) to the audio and video decoders and the audio and video processors for controlling the audio and video decoders and the audio and video processors. For example, video processor 125 may send video signals to video display 130 in response to a command from controller 145 and audio processor 135 may send audio signals to speakers 140 in response to another command from controller 145.

For one embodiment, controller 145 includes processor 150 for processing computer/processor-readable instructions. These computer-readable instructions are stored in a memory 155, such as a computer-usable media, and may be in the form of software, firmware, or hardware. In a hardware solution, the instructions are hard coded as part of processor 150, e.g., an application-specific integrated circuit (ASIC) chip. In a software or firmware solution, the instructions are stored for retrieval by the processor 150. Some additional examples of computer-usable media include static or dynamic random access memory (SRAM or DRAM), read-only memory (ROM), electrically-erasable programmable ROM (EEPROM or flash memory), magnetic media and optical media, whether permanent or removable. Most consumer-oriented computer applications are software solutions provided to the user on some removable computer-usable media, such as a compact disc read-only memory (CD-ROM). The computer-readable instructions cause controller 145 to perform various methods, such as controlling the audio and video decoders and the audio and video processors. For example, computer-readable instructions may cause controller 145 to send commands to audio processor 135 to apply certain gains and timing (e.g., time delays) to the audio signals received at audio processor 135 so that audio processor 135 can correlate the sound from the speakers to a portion of video display 130 from which the sound appears to be originating, as discussed below.

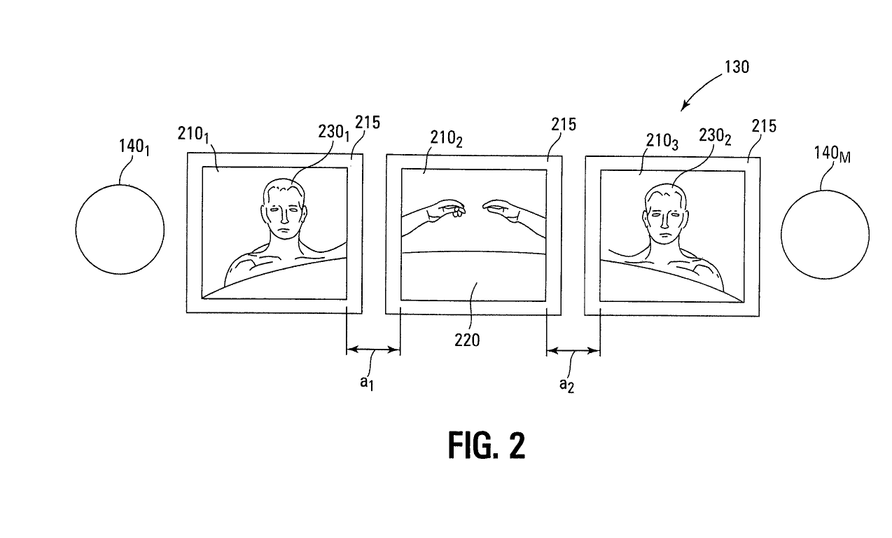

FIG. 2 illustrates an example speaker and video display setup in a room, such as a video conference room, according to another embodiment. For example, video display 130 may include a single video monitor or a plurality of video monitors 210, as shown in FIG. 2. A distance a₁ may separate video monitor 210₁ from video monitor 210₂, and a distance a₂ may separate video monitor 210₂ from video monitor 210₃. For one embodiment, the distances a include the bezels 215 of the video monitors 210 and a gap between these bezels. For another embodiment, the gap may be eliminated; the bezels may be eliminated; or both the gap and the bezels may be eliminated.

The images displayed on video display 130 may be received from one or more remote video conference rooms, e.g., as described above in conjunction with FIG. 1. For example, encoded audio signals V₁-V_{N} (FIG. 1) may be received at video signal decoder 110 from different locations within a single remote video conference room, such as cameras placed at different locations within the single remote video conference room. Alternatively, encoded video signals V₁-V_{N} may be respectively received at video signal encoder 110 from different remote video conference rooms. For example, encoded video signal V₁ may be received from one or more cameras in a first video conference room, encoded video signal V₂ from one or more cameras in a second video conference room, and encoded video signal V_{N} from one or more cameras in an Nth video conference room.

For one embodiment, the video configurations are predetermined for each video-conference-room configuration. For example, it may be predetermined that video contained in respective ones of video signals V₁-V_{N} be displayed on respective ones of predetermined video monitors of a display having multiple video monitors. For example, for a display 130 with three video monitors 210, as shown in FIG. 2, it may be predetermined that the video contained in decoded video signal V₁ be displayed on monitor 210₁, the video contained in decoded video signal V₂ be displayed on monitor 210₂, and the video contained in decoded video signal V_{N} be displayed on monitor 210₃. That is, it is predetermined that a specific video monitor 210 display the video contained in a specific video signal V.

For embodiments where a single video monitor is used, it is predetermined that video contained in respective ones of video signals V₁-V_{N} be displayed on respective ones of predetermined portions of the single video monitor. For example, it may be predetermined that the video contained in decoded video signal V₁ be displayed in a left portion of the single monitor, the video contained in decoded video signal V₂ be displayed in a center portion of the single monitor, and the video contained in decoded video signal V_{N} be displayed in a right portion of the single monitor.

For embodiments where video monitors are part of a projection system, decoded video signals V₁, V₂, and V_{N} are received at one or more projectors from video processor 125, and the images from decoded video signals V₁, V₂, and V_{N} are respectively projected onto the respective video monitors 210₁, 210₂, and 210₃ or are respectively projected onto a left portion, a center portion, and a right portion of a single video monitor. For embodiments where video monitors 210₁, 210₂, and 210₃ are projectionless video monitors, decoded video signals V₁, V₂, and V_{N} are respectively sent directly to video monitors 210₁, 210₂, and 210₃ from video processor 125. For a single projectionless video monitor, for example, decoded video signals V₁, V₂, and V_{N} may be respectively sent directly to a left portion, a center portion, and a right portion of that monitor.

For one embodiment, video contained in the video signals V₁-V_{N} is adjusted so that the objects, such as a table 220 and participants 230 appear continuous across the boundaries of video monitors 210. For other embodiments, cameras at the originating remote video conference rooms may be adjusted so that the objects appear continuous across the boundaries of video monitors 210.

For one embodiment, a speaker 140 may be located on either side of video display 130. For another embodiment, a speaker may be located below one or more of the video monitors 210 in lieu of or in addition to speakers 140. Speakers may also be located on the ceiling and/or the floor of the video conferencing room. During operation, as video images are displayed on video monitors 210, audio signals (e.g., sometimes referred to as audio images) corresponding to the video images are sent to speakers 140.

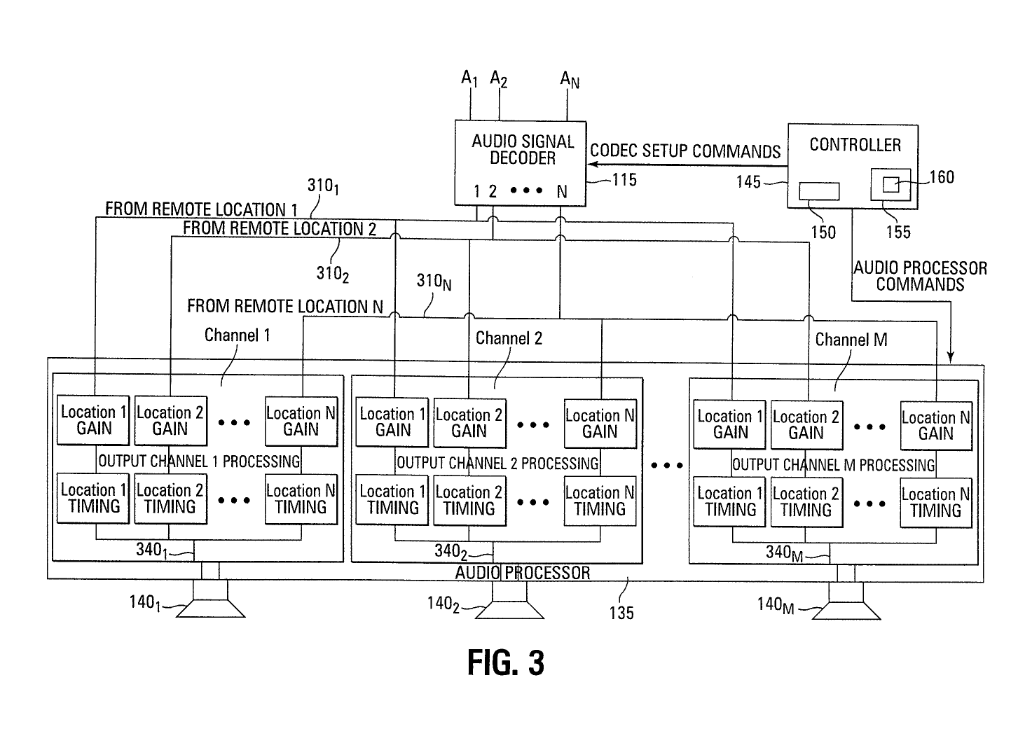

FIG. 3 is a block diagram illustrating the audio components of audio/video system 100, including audio signal decoder 115, audio processor 135, and speakers 140, according to another embodiment. In particular, FIG. 3 illustrates gains and timing applied to audio signals 310 received at audio processor 135. For one embodiment, the gains and timing are applied in response to commands from controller 145, according to the computer-readable instructions stored in memory 155.

For one embodiment, encoded video signals V₁-V_{N} respectively correspond to encoded audio signals A₁-A_{N}. That is, the audio contained in respective ones of audio signals A₁-A_{N} corresponds the video contained respective ones of video signals V₁-V_{N}. For one embodiment, encoded audio signals A₁-A_{N} (FIG. 3) may be received at audio signal decoder 115 from different locations within a single remote video conference room, such as microphones placed at different locations within a remote video conference room, and the respective corresponding encoded video signals V₁-V_{N} may be received at video signal encoder 110 from cameras placed at different locations within that video conference room.

Alternatively, encoded audio signals A₁-A_{N} may be respectively received at audio signal encoder 115 from different remote video conference rooms, and the respective corresponding encoded video signals V₁-V_{N} may be respectively received at video signal encoder 110 from those conference rooms. For example, encoded audio signal A₁ may be received from one or more microphones in a first video conference room, and the corresponding encoded video signal V₁ may be received from one or more cameras in the first video conference room. Similarly, encoded audio signal A₂ may be received from one or more microphones in a second video conference room, and the corresponding encoded video signal V₂ may be received from one or more cameras in the second video conference room. Likewise, encoded audio signal A_{N} may be received from one or more microphones in an Nth video conference room, and the corresponding encoded video signal V_{N} may be received from one or more cameras in the Nth video conference room.

Audio signal decoder 115 sends decoded audio signals 310₁ to 310_{N} to each of output channels 1-M of audio processor 135, as shown in FIG. 3, where channels 1-M are coupled one-to-one to speakers 140₁-140_{M}. Note that decoded audio signals 310₁ to 310_{N} are respectively decoded from encoded audio signals A₁-A_{N}. As such, decoded audio signals 310₁ to 310_{N} are respectively received from either different locations of a single remote video conference room or from different remote video conference rooms. That is, remote locations 1-N in FIG. 3 may be different locations in a single remote video conference room or different remote video conference rooms or a combination thereof. For example, participants 230₁ and 230₂ in FIG. 1 may be at different locations (e.g., remote locations 1 and N, respectively) within a single remote video conference room. Alternatively, participant 230₁ may be one of one or more participants at a first remote video conference room (e.g., remote location 1), and participant 230₂ may be one of one or more participants at a second remote video conference room (e.g., remote location N).

Channels 1-M respectively output audio signals 340₁-340_{M} to speakers 140₁-140_{M}. For example, at each of channels 1-M, audio processor 135 applies a gain and/or timing to the signals 310 received at that channel, e.g., in response to commands from controller 145. Then, at each channel, the audio signals 310₁-310_{M} with the respective gains and/or timing applied thereto are respectively output as audio signals 340₁-340_{M}. For one embodiment, the timing may involve delaying one or more of audio signals 340₁-340_{M} with respect to others.

For another embodiment, when it is determined that the sound corresponding to an audio signal appears to be originating from certain a portion of video display 130, such as video monitor 210₁ when participant 230₁ is speaking (FIG. 2), the audio signal received at a speaker that is further away from that portion of video display 130, e.g., speaker 140_{M}, may have a lower gain than a speaker that is closer to that portion of video display 130, e.g., speaker 140₁, and/or may be delayed with respect to the speaker that is closer to that portion of video display 130. This acts to correlate the locations of the speakers, and thus the sound therefrom, to the location on the video display from which the sound appears to be originating.

For one embodiment, the portion of video display 130 from which the sound appears to be originating is predetermined in that the predetermined portion of video display 130 on which the image, such as participant 230₁, that is producing the sound defines and corresponds to the portion of video display 130 from which the sound appears to be originating. The distance from each speaker 140 to different portions of the video display 130 is also predetermined, for some embodiments, so that the distance between each speaker 140 and each portion of video display 130 from which the sound appears to be originating is predetermined. Therefore, the audio signal corresponding to the video signal that contains the image producing the sound can be adjusted, as just described, based on the predetermined distances between the predetermined portion of the video display 130 from which the sound appears to be originating and the speakers 140.

For the example of FIG. 2, where speaker 140₁ is located to the left of video display 130 and speaker 140_{M} is located to the right of video display 130, when participant 230₁ (e.g., at remote location 1) is speaking and participant 230₂ (e.g., at remote location N) is not speaking, an audio signal 310₁, corresponding to the video signal that produces the image of participant 230₁, is received at channel 1 and channel M of audio processor 135. Note that in this scenario, the sound corresponding to audio signal 310₁ originates from the portion of video display 130 (e.g., the apparent sound origin on the video display), e.g., from participant 230₁, that is closer to speaker 140₁. Note further that location of the apparent sound origin on the video display is predetermined in that the location of the apparent sound origin corresponds to and is defined by the predetermined portion on video display 130, e.g., video monitor 210₁, where the image of participant 230₁ contained in the video signal is displayed. Moreover, the distances between speakers 140₁ and 140_{M} and the predetermined apparent sound origin on the video display may be predetermined.

In order for the sound coming from the speakers to appear as though it is originating from participant 230₁, the location 1 gain applied to audio signal 310₁ at channel 1, e.g., in response to a command from controller 145, may be greater than the location 1 gain applied to audio signal 310₁ at channel M, e.g., in response to a command from controller 145. That is, a higher gain is applied the audio signal 310₁ destined for speaker 140₁ that is closer to the apparent sound origin on the video display, such as participant 230₁, than the audio signal 310₁ destined for speaker 140_{M} that is further from the apparent sound origin on the video display. For example, the sound pressure level of the audio signal 340₁ resulting from the gain applied to audio signal 310₁ destined for speaker 140₁ is greater than the sound pressure level of the audio signal 340_{M} resulting from the gain applied to audio signal 310₁ destined for speaker 140_{M}.

For other embodiments involving additional speakers, the gain may be applied to the audio signals 310, e.g., in response to a command from controller 145, according to the distance from the apparent sound origin on the video display, such as participant 230₁, to the speakers 140 for which those audio signals 310 are destined. For example, the gain may decrease as the distance from participant 230₁ to a speaker increases. For example, if speaker 140₂ is closer to participant 230₁ than speaker 140_{M} and further away from participant 230₁ than speaker 140₁, the gain applied at channel 2 to audio signal 310₁ destined for speaker 140₂ might be less than the gain applied to the audio signal 310₁ destined for speaker 140₁ and greater than audio signal 310₁ destined for speaker 140_{M} such that the sound pressure level of audio signal 340₂ is greater than the sound pressure level of audio signal 340_{M} and less than the sound pressure level of audio signal 340₁.

Continuing with the example illustrated in FIG. 2 when participant 230₁ is speaking and participant 230₂ is not speaking, in order for the sound coming from the speakers to appear as though it is originating from participant 230₁, the timing may be adjusted, e.g., in response to a command from controller 145, so that audio signal 340_{M} is delayed with respect to audio signal 340₁ so that the sound from speaker 140₁ is heard first, giving the impression that the sound is coming from substantially entirely speaker 140₁ and thus from participant 230₁. This is known as the precedence effect. For example, the delay is applied to the audio signal 310₁ that is destined for speaker 140_{M} at channel M. That is, the audio signal 310₁ destined for the speaker 140 that is further away from the apparent sound origin on the video display is delayed with respect to the audio signal 310₁ destined for the speaker 140 that is closer to the apparent sound origin on the video display.

For other embodiments involving additional speakers, the delay, e.g., in response to a command from controller 145, may be applied to the audio signals 310 according to the distance from the apparent sound origin on the video display, such as participant 230₁, to the speakers 140 for which those audio signals 310 are destined. For example, the delay may decrease as the distance from participant 230₁ to a speaker decreases or vice versa, starting with a zero delay, for example, applied to the signal destined for the speaker closest to the apparent sound origin on the video display. For example, if speaker 140₂ is closer to participant 230₁ than speaker 140_{M} and further away from participant 230₁ than speaker 140₁, the delay applied at channel 2 to audio signal 310₁ destined for speaker 140₂ might be less than the delay applied to the audio signal 310₁ destined for speaker 140_{M} and greater than the delay (e.g., a zero delay) applied to the audio signal 310₁ destined for speaker 140₁.

For one embodiment, the delay may be on the order of the time delay resulting from the difference in path lengths between the speakers and a certain location within the video conference room in which the speakers are located, such as the location of a table in the video conference room at which participants may be positioned. For example, the delay applied to audio signal 310₁ destined for speaker 140_{M} might be on the order of the delay due to the difference in path lengths between speakers 140₁ and 140_{M} and the certain location. For another embodiment, the delay may be, for example, substantially equal to or greater than the delay due to the difference in path lengths between the speakers and the certain location.

For the example illustrated in FIG. 2 when participant 230₁ is speaking and participant 230₂ is not speaking, both the gain and signal timing may be adjusted, e.g., in response to a command from controller 145. For example, the sound pressure level of the audio signal 340₁ resulting from the gain applied to the audio signal 310₁ destined for speaker 140₁ may greater than the sound pressure level of the audio signal 340_{M} resulting from the gain applied to the audio signal 310₁ destined for speaker 140_{M}. The audio signal 340_{M} may also be delayed with respect to the audio signal 340₁. That is, when the sound corresponding to the audio signal 310₁ is originating from a portion of a video display that is closer to speaker 140₁ than speaker 140_{M}, the audio signal 340_{M} received at speaker 140_{M} has a lower gain and sound pressure level than the audio signal 340₁ received at speaker 140₁ and is delayed with respect to the audio signal 340₁ received at speaker 140₁.

For other embodiments involving additional speakers, both a delay and a gain may be applied to the audio signals 310, e.g., in response to a command from controller 145, according to the distance from the apparent sound origin on the video display, such as participant 230₁, to the speakers 140 for which those audio signals 310 are destined. For example, if speaker 140₂ is closer to participant 230₁ than speaker 140_{M} and further away from participant 230₁ than speaker 140₁, the audio signal 340₂ received at speaker 140₂ has a lower gain and sound pressure level than the audio signal 340₁ received at speaker 140₁ and is delayed with respect to the audio signal 340₁ received at speaker 140₁, and the audio signal 340_{M} received at speaker 140_{M} has a lower gain and sound pressure level than the audio signal 340₂ received at speaker 140₂ and is delayed with respect to the audio signal 340₂ received at speaker 140₂.

Although the above examples were directed to audio signals 310₁ from remote location 1, it will be appreciated that similar examples may be provided for each of the remaining audio signals 310 for the remaining remote locations. For example, participant 230₂ may be at remote location N. For an example where participant 230₂ is speaking and participant 230₁ is not, the audio signal 310_{N}, corresponding to the video signal that produces the image of participant 230₂ on video monitor 130, destined for speaker 140₁, which is further away from participant 230₂ than speaker 140_{M}, may have lower gain applied thereto at channel 1 than the gain applied the audio signal 310_{N} destined for speaker 140_{M} at channel M and/or the audio signal 310_{N} destined for speaker 140₁ may be delayed with respect to the audio signal 310_{N} destined for speaker 140_{M}. Therefore, the audio signal 340₁ output from channel 1 and received at speaker 140₁ will have a lower sound pressure level than the audio signal 340_{M} output from channel M and received at speaker 140_{M} and/or the audio signal 340₁ will be delayed with respect to audio signal 340_{M}. As a result, the sound appears to be coming from speaker 140_{M}, which is closest to participant 230₂, who is speaking.

For one embodiment, audio signal gains and/or delays may be determined for each speaker for different types of video conferencing systems (e.g., different video displays, different speaker setups, etc.) and different types video conference rooms (e.g., different distances between the video displays and participant seating locations, different distances between the speakers and participant seating locations different numbers of participants, different distances between the speakers and various locations of the video display, etc.). For example, numerical values corresponding to different audio signal gains and/or time delays may be stored in memory 155 of controller 145, e.g., in a look-table 160, as shown in FIG. 3. Controller 145 may select numerical values for the audio signal gains and/or delays for each speaker according to the type of video conferencing system and the type of video conferencing room. For example, the controller 145 may enter the look-up table 160 with the distance between each speaker and the apparent sound origin on the video display and extract the numerical values for the audio signal gains and/or delays for each speaker according to the distance from that speaker to the apparent sound origin on the video display.

For another embodiment, a numerical value representative of the distance from each speaker to different locations on the video display may be stored in memory 155, such as in look-up table 160, for a plurality of video conference rooms. In addition, the predetermined locations on the video display at which the video from the video signals, and thus the predetermined locations of the apparent sound origins, may also be stored in memory 155, such as in look-up table 160, for a plurality of video conference room configurations. Therefore, controller 145 can enter look-up table 160 with given room configuration and cause the video contained in each video signal to be displayed at the predetermined locations on the video display. In addition, controller 145 can enter look-up table 160 with a predetermined location of the apparent sound origin on the video display and extract the numerical value representative of the distance from each speaker to the apparent sound origin on the video display for the given room, and subsequently instruct audio processor 135 to adjust the gains and delays for each speaker according to the determined distances.

### CONCLUSION

Although specific embodiments have been illustrated and described herein it is manifestly intended that the scope of the claimed subject matter be limited only by the following claims and equivalents thereof.

What is claimed is:

1. A computer-usable medium containing computer-readable instructions for causing an audio/video system to perform a method, comprising:
sending an audio signal to a plurality of speakers of the audio/video system; and
adjusting a delay and/or a gain applied to the audio signal sent to each speaker of the plurality of speakers based on a distance from that speaker to an apparent sound origin on a video display of the audio/video system.

2. The computer-usable medium of claim 1, wherein the method further comprises increasing the delay applied to the audio signal sent to each speaker of the plurality of speakers as the distance from the apparent sound origin on the video display to that speaker increases and/or increasing the gain applied to the audio signal sent to each speaker of the plurality of speakers as the distance from the apparent sound origin on the video display to that speaker decreases.

3. The computer-usable medium of claim 1, wherein, the method further comprises displaying an image contained in a video signal corresponding to the audio signal at a predetermined location on the video display of the audio/video system, wherein the predetermined location corresponds to the apparent sound origin on the video display.

4. The computer-usable medium of claim 1, wherein the method further comprises determining the distance from the sound origin on the video display to each of the plurality speakers from a look-up table.

5. An audio/video system, comprising:
a video display;
a video processor coupled to the video display, the video processor configured to send a video signal to the video display;
a plurality of speakers;
an audio processor coupled to the plurality of speakers, the audio processor configured to send an audio signal, corresponding to the video signal, to the plurality of speakers; and
a controller coupled to the audio processor and the video processor;
wherein the controller is configured to apply a delay and/or a gain to the audio signal sent to each speaker of the plurality of speakers based on a distance from that speaker to an image on the video display, corresponding to the video signal, from which sound appears to be emitted.

6. The audio/video system of claim 5, further comprising a memory configured to store numerical values corresponding to the gain applied to the audio signal sent to each speaker of the plurality of speakers and/or numerical values corresponding to the delay applied to the audio signal sent to each speaker of the plurality of speakers.

7. The audio/video system of claim 5, wherein the delay applied to the audio signal sent to each speaker of the plurality of speakers increases as the distance from that speaker to the image on the video display increases and/or the gain applied to the audio signal sent to each speaker of the plurality of speakers increases as the distance from that speaker to the image on the video display decreases.

8. A computer-usable medium containing computer-readable instructions for causing an audio/video system to perform a method, comprising:
sending an audio signal to at least first and second speakers of the audio/video system; and
when the second speaker is closer to an apparent sound origin on a video display of the audio/video system than the first speaker, delaying the audio signal sent to the first speaker with respect to the audio signal sent to the second speaker and/or increasing a gain of the audio signal sent to the second speaker above the gain of the audio signal sent to the first speaker.

9. The computer-usable medium of claim 8, wherein the method further comprises:
sending the audio signal to a third speaker of the audio/video system; and
when the third speaker is further away from the apparent sound origin on the video display than the first speaker, delaying the audio signal sent to the third speaker with respect to the first speaker and/or decreasing a gain of the audio signal sent to the third speaker below the gain of the audio signal sent to the first speaker.

10. The computer-usable medium of claim 8, wherein the method further comprises determining the gain of the audio signals sent to the first and second speakers from a look-up table and/or determining an amount by which the audio signal sent to the first speaker is delayed with respect to the audio signal sent to the second speaker from a look-up table.

11. The computer-usable medium of claim 8, wherein the apparent sound origin corresponds to an image that is displayed at a predetermined location on the video display.

12. The computer-usable medium of claim 8, wherein the delay is on the order of a time delay due to a difference in path lengths between the first and second speakers and a certain location within a room in which the speakers are located.

13. The computer-usable medium of claim 8, wherein the method further comprises determining the distances between the first and second speakers and the apparent sound origin on the video display from a look-up table.

14. An audio/video system for a video conferencing room, comprising:
a video display;
a video processor coupled to the video display;
at least first and second speakers;
an audio processor coupled to the at least first and second speakers; and
a controller coupled to the audio processor and the video processor;
wherein the video processor is configured to send a video signal to the video display;
wherein the audio processor is configured send an audio signal to the first speaker and the second speaker; and
wherein when the second speaker is closer to an image on the video display that corresponds the video signal, the audio processor is configured to delay the audio signal sent to the first speaker with respect to the audio signal sent to the second speaker and/or to increase a gain of the audio signal sent to the second speaker above the gain of the audio signal sent to the first speaker in response to a command from the controller.

15. The audio/video system of claim 14, wherein the controller is configured to cause the image on the video display to be displayed at a predetermined location on the video display.

16. The audio/video system of claim 15, further comprising a memory configured to store the predetermined location.

17. The audio/video system of claim 16, wherein the memory is configured to store the distances between the predetermined location on the video display and the first and second speakers.

18. A method of operation of an audio/video system, comprising:
sending an audio signal to a plurality of speakers of the audio/video system;
displaying video, corresponding to the audio signal, at a predetermined location on a video display of the audio/video system, wherein the predetermined location is located at predetermined distances from respective speakers of the plurality of speakers; and
adjusting a delay applied to the audio signal sent to each speaker of the plurality of speakers based on the predetermined distance from the predetermined location on the video display to that speaker and/or adjusting a gain applied the audio signal sent to each speaker of the plurality of speakers based on the predetermined distance from the predetermined location on the video display to that speaker.

19. The method of claim 18, further comprising increasing the delay applied to the audio signal sent each speaker of the plurality of speakers as the distance from the predetermined location on the video display to that speaker increases and/or increasing the gain applied to the audio signal sent each speaker of the plurality of speakers as the distance from the predetermined location on the video display to that speaker decreases.

20. The method of claim 18, wherein the delay and/or gain applied to each speaker of the plurality of speakers is stored in a memory of the audio/video system.
